(19) United States
(12) Patent Application Publication
(10) Pub. No.: US 2011/0162926 A1
(43) Pub. Date: Jul. 7, 2011

(54) BRAKE DISK HAVING A BRAKE DISK POT

(75) Inventors: Siegfried Botsch, Grafenau (DE); Klaus Jaeckel, Nersingen (DE); Martin Lesch, Waiblingen (DE); Christian Quinger, Schorndorf (DE); Thomas Steinhauer, Esslingen (DE); David Wilke, Allmersbach im Tal (DE)

(73) Assignee: DAIMLER AG, Stuttgart (DE)

(21) Appl. No.: 13/062,972

(22) PCT Filed: Aug. 25, 2009
(86) PCT No.: PCT/EP2009/006145

§ 371 Date: Mar. 9, 2011

(30) Foreign Application Priority Data
Sep. 10, 2008 (DE) 10 2008 046 546.1

(51) Int. Cl. F16D 65/12; F16D 65/847; B23P 11/00

(52) U.S. Cl. 188/218 XL; 29/525.11

(57) ABSTRACT

The invention relates to a brake disc having a brake disc pot (42) and a friction ring (10) which is positively connected to the brake disc pot via toothing (50). The friction ring (10) comprises two friction ring halves (12, 14), wherein the toothing extends across only one of the friction ring halves. In this manner it is possible to mount through-passages (30) axially adjacent to the toothing running around the friction ring half on the interior circumference of the friction ring, said passages connecting the interior circumference of the friction ring to an interior ventilation arrangement of the friction ring. In this manner both a good force transmission and a stable positive connection is ensured between the friction ring and the brake disc pot, as is an efficient cooling by means of an interior ventilation of the friction ring.

The invention relates to a brake disc, in particular for a motor vehicle, of the type specified in the preamble of patent claim 1.

A brake disc of this type is for example known from DE 101 25 111 A1. It comprises a friction ring and a retaining part, the friction ring and the retaining part being positively connected to each other in the radial direction of the brake disc via a toothing profile. The friction ring and the retaining part are axially secured by a continuous circlip guided in a groove of the friction ring and/or the retaining part. The toothing profile is designed as involute toothing.

Such positive connections between friction rings and retaining parts or brake disc pots via toothing offer the two parts good mutual security in the radial direction while transmitting force between the brake disc pot and the friction ring. As this type of connection requires a very large part of the interior circumference of the friction ring for the toothing, the use of such positive connections poses a problem for ventilated brake discs. Between the side faces of the friction rings of these brake discs there runs a system of ventilation passages through which air flows during the operation of the brake disc in order to remove heat from the friction rings. Inadequate heat removal results in a so-called umbrella formation of the brake disc, a term describing a doming of the brake disc in the axial direction caused by uneven heating. If the interior circumference of the friction ring is occupied by toothing, the ventilation arrangement cannot extend unbroken through the friction ring, because the interior circumference cannot be provided with through-holes connecting the air passages to ambient air. At high thermal loading such brake discs are therefore prone to umbrella formation and possibly to crack formation.

The present invention is therefore based on the problem of further developing a brake disc of the type referred to above, with the air of ensuring both a positive connection between the friction ring and the brake disc and good heat removal from the friction ring in the operation of the brake disc.

This problem is solved by a brake disc with the features of patent claim 1.

The brake disc according to the invention comprises a brake disc pot and a friction ring positively connected thereto in the radial direction. The friction ring comprises two friction ring halves joined via spacer means, between which air passages for an interior ventilation arrangement are provided. According to the invention, it is provided that the positive connection comprises toothing which extends across the interior circumference of only one of the friction ring halves and which can be brought into engagement with complementary toothing running along the exterior circumference of the brake disc pot. As the toothing covers only one friction ring half, additional area is available at the interior circumference of the friction ring for providing at least one through-hole of the interior ventilation arrangement at the interior circumference of the friction ring axially adjacent to the toothing. Air can therefore flow continuously through the friction ring from the exterior to the interior circumference via the interior ventilation arrangement, which improves the cooling of the friction ring and helps in the prevention of umbrella and crack formation. At the same time, the toothing provides for a stable, positive connection with the brake disc pot.

In a particularly preferred embodiment, the toothing is designed as helical toothing in order to ensure a low-wear transmission of braking forces between the brake disc pot and the friction rings, the compression remaining constant to a very high degree across the tooth flanks of the helical toothing. Helical toothing further allows for a certain degree of play in the radial direction to compensate for any thermal expansion of the brake disc and to avoid thermal stresses. In a particularly low-wear manner, the helical toothing allows for reversible and even expansion and contraction in the radial direction. This has a particularly beneficial effect on the service life of the brake disc.

In helical toothing, the toothing between the brake disc pot and the friction ring is based on helical tooth flanks of the brake disc pot, which engage complementary helical toothing of the friction ring. The included angle of two adjacent tooth flanks of the brake disc pot or the friction ring respectively preferably lies in the range between 5 and 45 degrees. The inclination of individual tooth flanks may be chosen differently. Preferably, the deviation of the side edge from the radial orientation (or the normal), hereinafter referred to as inclination, lies within the range between 2.5 and 22.5 degrees or else between −2.5 and −22.5 degrees. In a particularly preferred embodiment, the two side flanks of any tooth deviate from the normal by the same amount. Included angles in the range between 10 and 15 degrees are preferred in particular.

By systematically varying the inclination of adjacent tooth flanks in the brake disc pot, the fit of the components may further be optimised independent of the direction of rotation. Such a design provides that the tooth flanks which absorb the major part of the forces from the motor vehicle travelling forwards in the braking process are steeper than the corresponding adjacent tooth flanks. It may be advantageous to fix the degree of inclination on one side at 0 to 2.4 degrees. In this variant, the included angle is limited to not excessively high values from the above range. As a result, the inclination of the tooth flank on the other side is significantly increased, for example above 5 degrees and preferably to a maximum of 20 degrees.

In order to secure the brake disc pot and the friction ring against axial movement as well, at least one axial securing element is further provided to connect the brake disc pot to the friction ring. This is preferably placed in a location opening extending radially within the friction ring, the friction ring being movable relative to the securing element in the region of the location opening. This capacity of the securing element for radial movement relative to the friction ring further reduces the risk of umbrella formation due to uneven temperature distribution. In such a situation, the friction ring can freely expand in the axial direction without suffering the introduction of forces by the securing element which may result in umbrella formation or deformation and related crack formation. In this way, the service life of such brake discs is advantageously increased.

The securing element comprises a sleeve attached to the brake disc pot by means of a screw, the sleeve being placed in a radial through-opening and externally surrounding the circumference of the screw. By means of such a sleeve, the desired free movement of the friction ring relative to the securing element can be achieved in a simple manner.

The sleeve is a threaded sleeve, its thread matching that of the screw. The screw may alternatively be designed as a stud bolt.

The screw or stud bolt may be inserted from the inside, i.e. the side facing the brake disc pot, or from the outside and tightened against the sleeve. The sleeve or threaded sleeve is correspondingly introduced into the brake disc from the inside or from the outside. The sleeve is inserted into through-holes or through-openings extending radially through the brake disc which are provided for this purpose.

Preferably, a long threaded sleeve is fitted from the outside and a relatively short stud bolt is tightened against it from the inside. The length of the threaded sleeve preferably corresponds to 50% to 90% of the length of the through-opening of the brake disc. In this embodiment, the securing element includes a screw which is fastened to the brake disc pot by means of a sleeve.

It has further been found to be advantageous if the head of the screw has a smaller cross-section than the location opening. Such a screw can in particular be inserted from the exterior circumference of the friction ring via the through-opening, the smaller screw head permitting free movement in the location opening.

It has finally been found to be advantageous to provide a plurality of securing elements which are preferably oriented at identical mutual angles. This is a particularly reliable means for avoiding an umbrella formation of the friction ring or the brake disc. As the disc expands, as well as in normal operation, forces are evenly distributed along the disc circumference, so that material stresses are reduced.

The invention and its embodiments are explained in greater detail below with reference to the drawings.

Of the drawings:

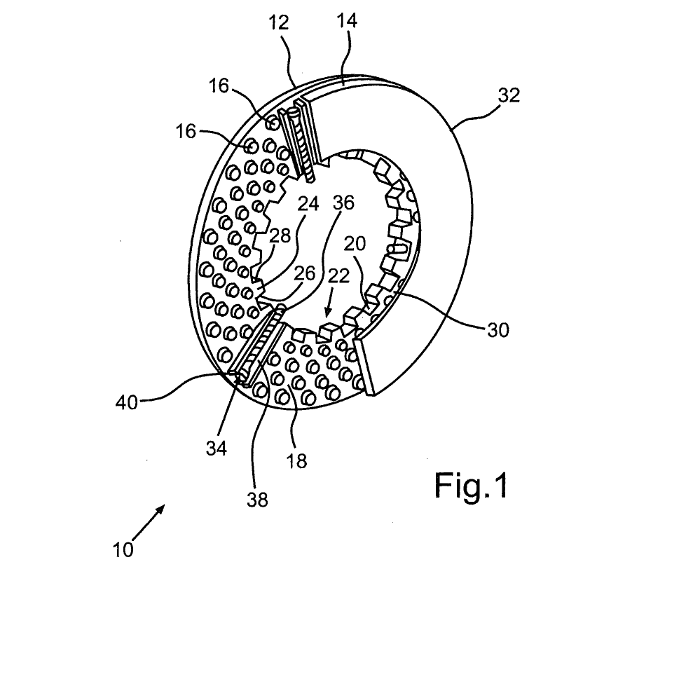

FIG. 1 is a partially cut-open perspective view of an embodiment of a friction ring of a brake disc according to the invention;

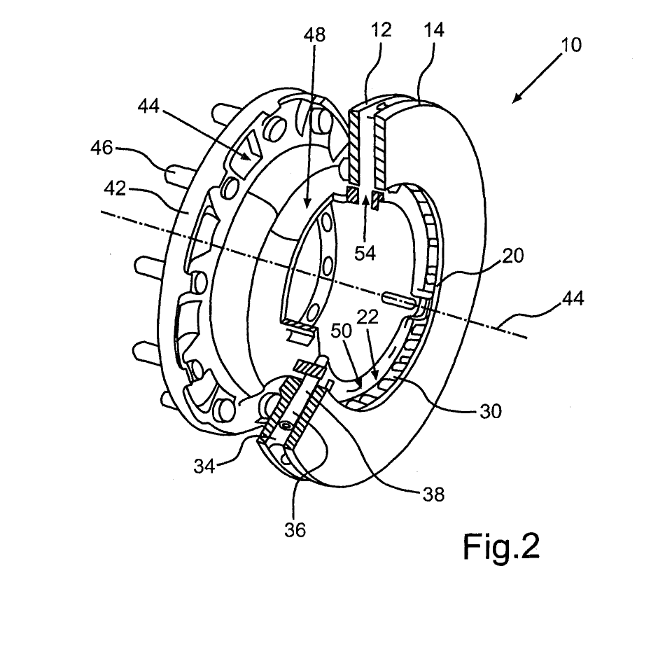

FIG. 2 is a partially cut-open perspective view of an embodiment of a brake disc according to the invention; and

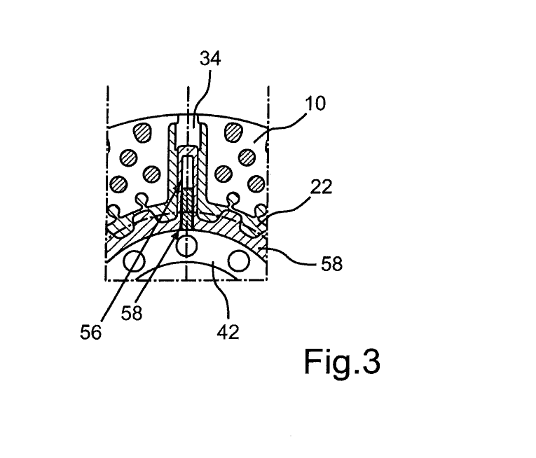

FIG. 3 is a sectional view of a type of attachment between the friction ring and the brake disc pot.

The friction ring 10 shown in FIG. 1 consists of two friction ring halves 12 and 14 joined to each other by spacers 16, of which only a few have been numbered for clarity. The free spaces 18 between the spacers 16 and the friction ring halves 12, 14 provide between the friction ring halves 12 and 14 a system of air passages for the internal ventilation of the friction ring 10. To provide a positive radial connection between the friction ring 10 and the brake disc pot, a toothing 22 extending along the internal circumference 20 of the friction ring half 12 is formed on the first friction ring half 12. The teeth 24 of the toothing 22, of which only a few have been numbered for clarity, are designed as helical toothing, i.e. the tooth flanks 26, 28 are planar and extend at an angle relative to each other. In the axial direction, adjacent to the toothing 22, through-openings 30 are provided which open the interior circumference 20 of the friction ring 10 towards the spaces 18 between the spacer elements 16, thus allowing for a continuous ventilation of the brake disc 10 from the exterior circumference 32 to the interior circumference 20. Further through-openings between the friction ring halves 12 and 14 accommodate securing elements 36 by means of which the friction ring 10 can be axially secured to a brake disc pot. The securing elements 36 are designed as screws accommodated in a sleeve 38 which is in turn located within the through-openings 34. The heads 40 of the screws 36 have a smaller diameter than the through-openings 34. By placing the screws 36 within the sleeves 38 and by giving the screw head 40 a smaller diameter, the friction ring 10 becomes movable in the radial direction relative to the securing elements 36, whereby any stresses caused by frictional loads in operation as the friction ring 10 expands thermally are minimised.

FIG. 2 illustrates the attachment of a friction ring 10 of this type to a brake disc pot 42. With respect to the axis 44, which forms an axis of rotational symmetry of the two components, the friction ring 10 is coaxial with the brake disc pot 42. The brake disc pot 42 has an edge region 44 with through-openings for screws 46 for securing the brake disc pot to a wheel hub. An inner cylindrical region 48 of the brake disc pot 42 is used for positively connecting the brake disc pot 42 to the friction ring 10. For this purpose, the inner region 48 has a toothing 50 running around an exterior circumference 52 of the inner region 48 of the brake disc pot 42. The toothing 50 complements the toothing 22 running around the interior circumference 20 of the friction ring 10. The two toothing systems therefore mesh and secure the friction ring against any radial movement relative to the brake disc pot 42. Even if the friction ring 10 is connected to the brake disc pot 42, it can be seen that the through-openings 30, which form the interior circumference 20 of the friction ring 10 with the ventilation passages represented by the free spaces 18, remain accessible. Good heat removal by ventilating the brake disc is therefore ensured in this case as well. The screws 36 in the through-openings 34 of the friction ring 10 engage with their end sections 54 corresponding threaded holes of the inner region 48 of the brake disc pot 42. In this process, the sleeves 38 come to bear against the wall of the inner region 48 of the brake disc pot 42. If the friction ring 10 expands locally or globally as a result of operational heat, the friction ring 10 remains capable of radial movement relative to the screws 36 or the sleeves 38, whereby material stresses are minimised even in the assembled state.

FIG. 3 shows an alternative way of attaching the friction ring 10 to the brake disc pot 42. In contrast to the embodiments shown in FIGS. 1 and 2, the friction ring 10 is additionally secured to the brake disc pot 42 not by a screw 36 tightened from the outside, i.e. from the exterior circumference of the friction ring 10, into a sleeve 38 provided in a through-opening 34, but rather from the interior circumference of the friction ring 10. For this purpose, a threaded sleeve 56 is first inserted into the through-opening 34 from the outside and then the brake disc pot 42 and the friction ring 10 are bolted to each other from the interior circumference of the friction ring 10 using a short stud bolt 58. The stud bolt 58 is significantly shorter than the threaded sleeve 56, extending along approximately 50% of its length. The length of the threaded sleeve 56 itself is approximately 50% to 90% of the length of the through-opening 34. FIG. 3 once again clearly shows the toothing between the brake disc pot 42 and the friction ring 10, a helical toothing 58 of the brake disc pot 42 meshing with a complementary helical toothing 22 of the friction ring 10.

The friction ring can be mounted as follows. The friction ring is first pushed laterally onto the wheel flange. The stud bolts are then inserted from the inside—as viewed from the axis of rotation of the friction ring—into the through-holes of the wheel flange and secured in the recesses of the wheel flange. Finally, the threaded sleeves are introduced from the outside into the through-holes of the friction ring and bolted together with the stud bolts.

This fixing method is particularly advantageous in terms of cost-effective brake maintenance, such as the replacement of the brake disc. Over the life of a brake disc, significant corrosion may develop at the threaded sleeve and the stud bolt. This could result in the breaking of the thread in an attempt to release the sleeve in order to replace the brake disc. In this case, the removal of the brake disc would involve considerable effort and cost. In the variant according to the invention, however, the break of the screw would not be damaging, because the broken screw can easily be driven through to the inside without involving any special effort or the risk of further damage.

1-12. (canceled)

13. A brake disc having a brake disc pot (42) and a friction ring (10) which is positively connected thereto radially and which comprises two friction ring halves (12, 14) joined via spacer means between which air passages (18) for an interior ventilation arrangement are provided,
wherein the positive connection comprises toothing (22) which extends across the interior circumference (20) of only one of the friction ring halves (12) and which can be brought into engagement with complementary toothing (50) running along the exterior circumference (52) of the brake disc pot (42),
wherein at least one through-opening (30) to the interior ventilation arrangement is provided axially adjacent to the toothing (22) running along the friction ring half (12) on the interior circumference (20) of the friction ring (10),
wherein the brake disc pot (42) and the friction ring (10) are secured against axial movement by at least one securing element (36) and the at least one securing element (36) is located in a location opening (34) extending radially within the friction ring (10) and wherein the friction ring (10) is radially movable relative to the securing element (36) in the region of the location opening (34), and
wherein the securing element (36) comprises a sleeve (38) which is secured to the brake disc pot (42) by means of a screw and which surrounds the external circumference of the screw (36).

14. The brake disc according to claim 13, wherein the toothing (22, 50) of the friction ring half (12) and the brake disc pot (42) is helical toothing.

15. The brake disc according to claim 14, wherein the included angle of two opposite side flanks of a tooth of the helical toothing lies within the range between 5 and 45 degrees.

16. The brake disc according to claim 13, wherein the amount of inclination on one side of a tooth of the helical toothing is 0 to 2.5 degrees and on the other side 5 to 20 degrees.

17. The brake disc according to claim 13, wherein the screw head (40) of the screw (36) has a smaller cross-section than the location opening (34).

18. The brake disc according to claim 13, wherein a plurality of securing elements (36) which are preferably distributed at identical mutual angles is provided.

19. A motor vehicle with at least one brake disc having a brake disc pot (42) and a friction ring (10) which is positively connected thereto radially and which comprises two friction ring halves (12, 14) joined via spacer means between which air passages (18) for an interior ventilation arrangement are provided,
wherein the positive connection comprises toothing (22) which extends across the interior circumference (20) of only one of the friction ring halves (12) and which can be brought into engagement with complementary toothing (50) running along the exterior circumference (52) of the brake disc pot (42),
wherein at least one through-opening (30) to the interior ventilation arrangement is provided axially adjacent to the toothing (22) running along the friction ring half (12) on the interior circumference (20) of the friction ring (10),
wherein the brake disc pot (42) and the friction ring (10) are secured against axial movement by at least one securing element (36) and the at least one securing element (36) is located in a location opening (34) extending radially within the friction ring (10) and wherein the friction ring (10) is radially movable relative to the securing element (36) in the region of the location opening (34), and
wherein the securing element (36) comprises a sleeve (38) which is secured to the brake disc pot (42) by means of a screw and which surrounds the external circumference of the screw (36).

20. A method for fitting a brake disc having a brake disc pot (42) and a friction ring (10) which is positively connected thereto radially and which comprises two friction ring halves (12, 14) joined via spacer means between which air passages (18) for an interior ventilation arrangement are provided, wherein the positive connection comprises toothing (22) which extends across the interior circumference (20) of only one of the friction ring halves (12) and which can be brought into engagement with complementary toothing (50) running along the exterior circumference (52) of the brake disc pot (42), wherein at least one through-opening (30) to the interior ventilation arrangement is provided axially adjacent to the toothing (22) running along the friction ring half (12) on the interior circumference (20) of the friction ring (10), wherein the brake disc pot (42) and the friction ring (10) are secured against axial movement by at least one securing element (36) and the at least one securing element (36) is located in a location opening (34) extending radially within the friction ring (10) and wherein the friction ring (10) is radially movable relative to the securing element (36) in the region of the location opening (34), and wherein the securing element (36) comprises a sleeve (38) which is secured to the brake disc pot (42) by means of a screw and which surrounds the external circumference of the screw (36), wherein the method comprises the following steps:
placing the brake disc laterally on the wheel flange,
inserting stud bolts into through-holes of the wheel flange from the inside,
securing of the stud bolts in recesses of the wheel flange, and
insertion of threaded sleeves into the through-holes from the outside and bolting together with the stud bolts.
